(19) United States
(12) Patent Application Publication
(10) Pub. No.: US 2002/0191222 A1
(43) Pub. Date: Dec. 19, 2002

(54) File generation apparatus and program recording medium

(76) Inventors: Kazutoshi Miyamura, Tsubata-machi (JP); Mitsuhiro Yashiki, Kosugi-machi (JP)

Correspondence Address: STAAS & HALSEY LLP, 700 11TH STREET, NW, SUITE 500, WASHINGTON, DC, 20001, US

(21) Appl. No.: 10/009,481

(22) PCT Filed: May 21, 2001
(86) PCT No.: PCT/JP01/04210

(30) Foreign Application Priority Data
May 22, 2000 (JP) 2000/149167

(51) Int. Cl. H04N 1/00

(52) U.S. Cl. 358/402

(57) ABSTRACT

A file generation apparatus has file generating and registering means for generating a file and registering the file in a file posting apparatus, URL generating means for generating URL notation that includes a description of full path information to the file registered in the file posting apparatus and a description to call a function which operates the file, and transmitting means for transmitting file registration information describing that generated URL notation to a transmission destination by using electronic mail, etc.

### TECHNICAL FIELD

The present invention relates to a file generation apparatus and program recording medium, and more particularly to a file generation apparatus that generates a file and registers it in a file posting apparatus, and allows a user to handle a registered file with good operability, and a program recording medium on which there is recorded a program used in the realization of that apparatus.

### BACKGROUND ART

A Web filing system, on receiving a file for which there is a registration request from a file generation apparatus, performs processing that stores it in a specified folder, and when there is a perusal request from a user via a Web browser, performs processing to post it.

On the other hand, a file generation apparatus, when a file is registered in a Web filing system, performs processing whereby the use of the file is contrived by transmitting electronic mail to users for whom there is a possibility of using the file, as shown in FIG. 6. That is to say, that electronic mail describes the URL (Uniform Resource Locators) notation of that Web filing system, the file name of the file, and the storage folder of the file.

On receiving electronic mail from this file generation apparatus, a user peruses that registered file using a Web browser. However, as a file generation apparatus assigns an appropriate file name using date and time information, etc., and has a configuration whereby a temporary folder held by the Web filing system is specified as a storage destination, normally these file names and folders comprising storage destinations are changed to easy-to-use items.

However, with a conventional technique of transmitting electronic mail such as that shown in FIG. 6, there is a problem in that the user cannot easily change the file name and storage folder of a file registered in a Web filing system.

That is to say, when the URL notation to be written in the electronic mail in FIG. 6 is clicked, the Web filing system first of all displays an initial screen such as that shown in FIG. 7.

Then, when a destination folder to be written in the electronic mail is clicked from within that initial screen, the Web filing system lists the names of files stored in that folder, and displays an operation menu screen such as that shown in FIG. 8 that displays an operation menu for the file.

Next, when an operation that orders a change of file name or storage folder is selected from within that operation menu screen, the Web filing system displays an operation screen such as that shown in FIG. 9 to be used for a change of file name or storage folder, and changes the file name or storage folder by accepting a corresponding input value.

By this means, for example, in the case of a file with the file name “id00903739” stored in a folder called “MarsLAN-test”, the file name is changed to “Discussion Minutes” and the storage folder to “Folder 1”.

Therefore, a user must carry out the following kinds of operations at the time of changing the file name or storage folder of a file registered in a Web filing system. That is, click a storage folder to be written in electronic mail from within the initial screen shown in FIG. 7. As a result of this, the operation menu screen shown in FIG. 8 is displayed. Next, select an operation that orders a change of file name or storage folder from within this operation menu screen. As a result of this, the operation screen in FIG. 9 is displayed. A change of file name or storage folder must be carried out by means of the above operations, and a file name or storage folder cannot be changed easily.

The present invention has been achieved by taking into account the actual situations described above, and it is an objective of the present invention to provide a new file generation apparatus that enables a user to handle a registered file with good operability.

Also, it is an objective of the present invention to provide a new program recording medium on which there is recorded a program used in the realization of a new file generation apparatus that enables a user to handle a registered file with good operability.

Moreover, the present invention has been achieved by taking into account the actual situations described above, and it is an objective of the present invention to provide an image scanner that enables a user to handle a registered file with good operability.

### DISCLOSURE OF THE INVENTION

In order to attain these objectives, a file generation apparatus of the present invention includes, file generating and registering means for generating a file and registering it in a file posting apparatus, URL generating means for generating URL notation that includes a description of full path information to the file registered in the file posting apparatus and a description to call function which operates the file, and transmitting means for transmitting file registration information that describes that URL notation to a transmission destination using electronic mail, etc.

Also, an image scanner of the present invention includes, an image processing section for reading image data and generating a file, file registration means for registering a file in a file posting apparatus, URL generating means for generating URL notation that includes a description of full path information to the file registered in the file posting apparatus and a description to call a function which operates the file, and transmitting means for transmitting file registration information that describes that URL notation to a transmission destination.

With a file generation apparatus or image scanner of the present invention configured in this way, the URL generating means generates URL notation that includes a description of full path information to the file registered in a file posting apparatus and a description to call a function which operates the file (for example, a file name change function or storage folder change function), and on receiving this, the transmitting means transmits file registration information that describes that URL notation to a transmission destination using electronic mail, etc. Thereafter, a user who receives notification of this file registration information can directly call a function such as a file name change function or storage folder change function only by clicking a URL notation described in the file registration information, and therefore can change a file name, storage folder, etc., easily. In this way, according to the present invention, a user can handle a file registered in a file posting apparatus with good operability.

Moreover, a program recording medium of the present invention provides a program to realize the above described kind of file generation apparatus in a form, whereby it is recorded on a recording medium such as a floppy disk that can be read by a computer. By this means, it is possible to easily realize a file generation apparatus that has characteristics as described above.

### BRIEF DESCRIPTION OF THE DRAWINGS

FIG. 1 shows a sample embodiment of the present invention.

FIG. 2 shows a processing flow executed by a file registration program.

FIG. 3 shows the processing flow executed by a Web browser, wherein more particularly, FIG. 3(a) shows processing relating to an initial screen, FIG. 3(b) shows processing relating to a file perusal screen, and FIG. 3(c) shows a file name change movement operation screen.

FIG. 4 is a sample embodiment of an electronic mail.

FIG. 5 is an explanatory drawing of a Web filing system operation screen.

FIG. 6 is an explanatory drawing of a Web filing system according to the conventional art.

FIG. 7 through FIG. 10 are explanatory drawings of the Web filing system in FIG. 6, wherein more particularly, FIG. 7 is an explanatory drawing of the initial screen, FIG. 8 is an explanatory drawing of the operation menu screen, FIG. 9 is an explanatory drawing of the operation screen, and FIG. 10 is an explanatory drawing of the operation menu screen.

### BEST MODE FOR CARRYING OUT THE INVENTION

Below, details of the present invention will be described according to an embodiment applied to a Web filing system connected to a LAN (Local Area Network).

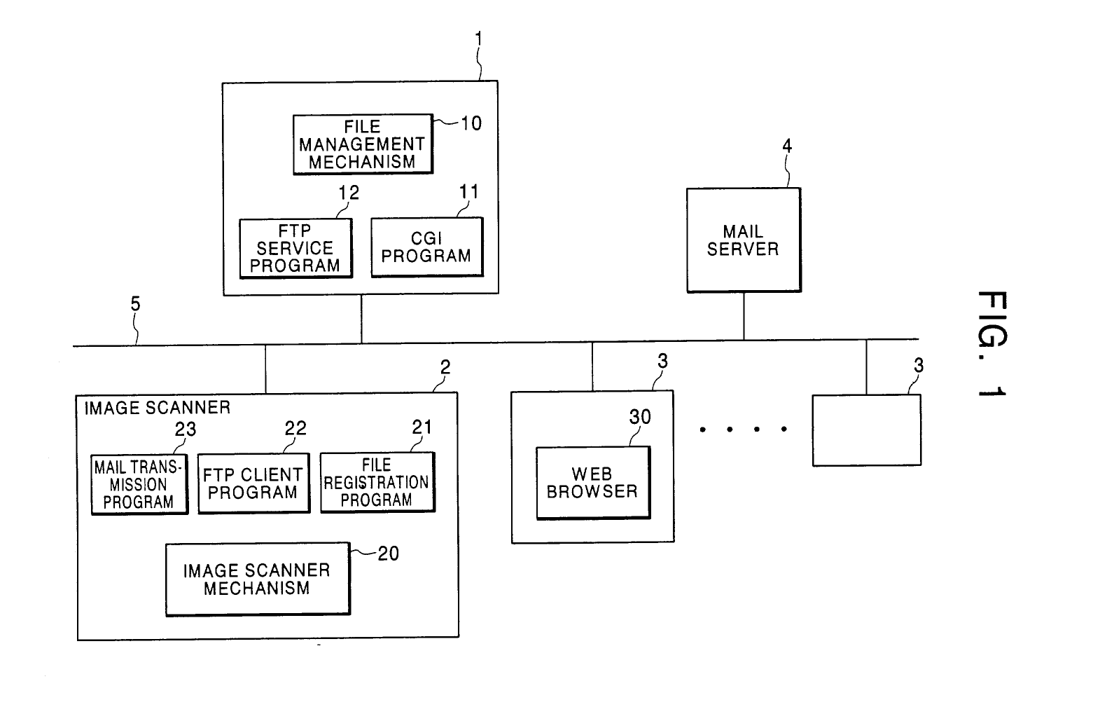

FIG. 1 shows a sample embodiment of the present invention. In FIG. 1, a Web filing system 1 performs processing to post file information. An image scanner 2 provided with the configuration of the present invention registers image data files in the Web filing system 1. Terminals 3 peruse files of image data, etc., registered in the Web filing system 1 using a Web browser 30. A mail server 4 has electronic mail server functions. A LAN 5 interconnects the Web filing system 1, image scanner 2, terminals 3, and mail server 4.

This Web filing system 1 comprises a file management mechanism 10, CGI (Common Gateway Interface) program 11, and FTP (File Transfer Protocol) service program 12. The file management mechanism 10 manages files to be posted on terminals 3. The CGI program 11 performs interactive processing on files managed by the file management mechanism 10, and also performs processing for posting these on terminals 3 using a Web service function (not shown) The FTP service program 12 receives files transferred from the image scanner 2.

On the other hand, the image scanner 2 provided with the present invention comprises an image scanner mechanism 20, file registration program 21, FTP client program 22, and mail transmission program 23. The image scanner mechanism 20 reads image data and generates a file. The file registration program 21 registers a file generated by the image scanner mechanism 20 in the Web filing system 1. In response to a command from the file registration program 21, the FTP client program 22 transfers a file for registration to the Web filing system 1. In response to a command from the file registration program 21, the mail transmission program 23 transmits file registration information to a terminal 3 using electronic mail.

Here, the file registration program 21, FTP client program 22, and mail transmission program 23 to be placed in the image scanner 2 provided with the present invention can be stored on a suitable recording medium such as semiconductor memory that can be read by a computer.

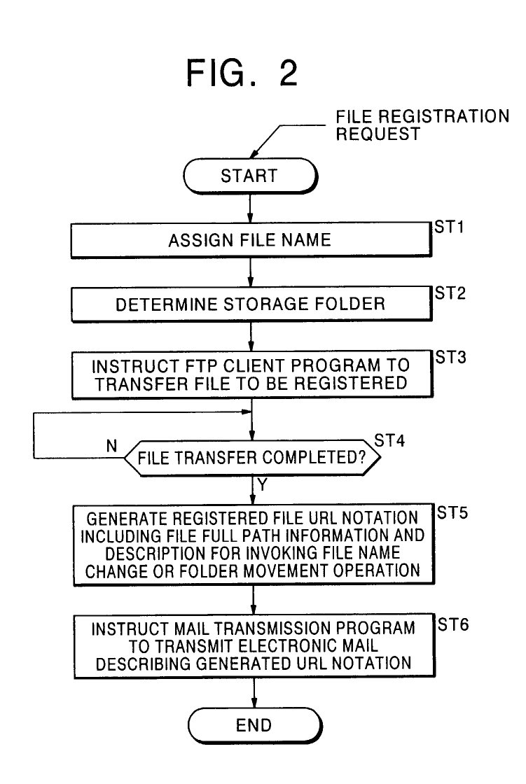

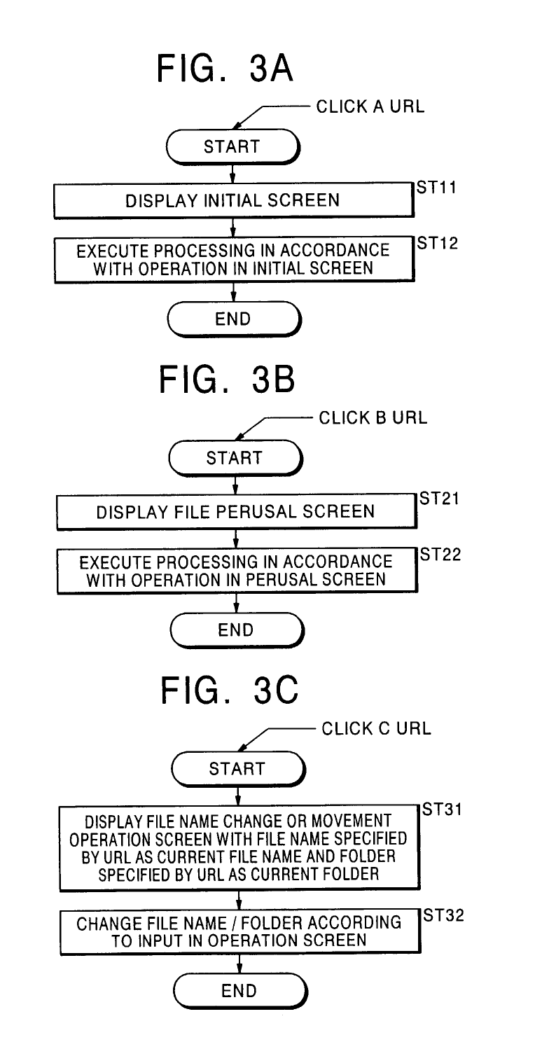

FIG. 2 shows a sample embodiment of the processing flow executed by the file registration program 21 to be placed in the image scanner 2, and FIG. 3 shows a sample embodiment of the processing flow executed by a Web browser 30 placed in a terminal 3.

Next, the processing by an image scanner 2 provided with the present invention will be described in detail in accordance with this processing flow.

A file generated by the image scanner mechanism 20 is specified by an operator operating the image scanner 2, and a file registration request is issued. In response to this, as shown in the processing flow in FIG. 2, the file registration program 21 placed in the image scanner 2 first, in step ST1, assigns a unique and appropriate file name to the file using date and time information, etc., and then in step ST2, determines the folder in which the file will be stored.

Here, with regard to storage folder determination, which folder can be used for storage may, for example, be notified from the Web filing system 1, and that folder determined as the storage destination.

Successively, in step ST3, the file registration program 21 specifies the storage folder to the FTP client program 22 and orders transfer of the file to be registered. In response to this command, the FTP client program 22 transfers the file to be registered to the Web filing system 1. By this means, the file to be registered is registered in the Web filing system 1. Then, in the next step, ST4, the file registration program 21 waits for the file transfer to be completed.

In step ST4, the file registration program 21 judges that the file to be registered has been registered in the Web filing system 1. Then, in step ST5, the file registration program 21 generates URL notation for that registered file. This URL notation includes full path information for the registered file and a description to call a file name change or folder movement operation. Registered file full path information is defined based on the assigned file name and the determined storage folder. A file name change or folder movement operation is a function provided by the CGI program 11. That is to say, the description to call that operation is a description that calls the corresponding function provided by the CGI program 11, and can be known in advance.

Successively, in step ST6, the file registration program 21 instructs the mail transmission program 23 to transfer electronic mail describing the generated URL notation, and terminates processing.

On receiving this command, the mail transmission program 23 generates electronic mail describing URL notation for the file registered in the Web filing system 1, and performs processing so that this is transmitted to a terminal 3 via the mail server 4.

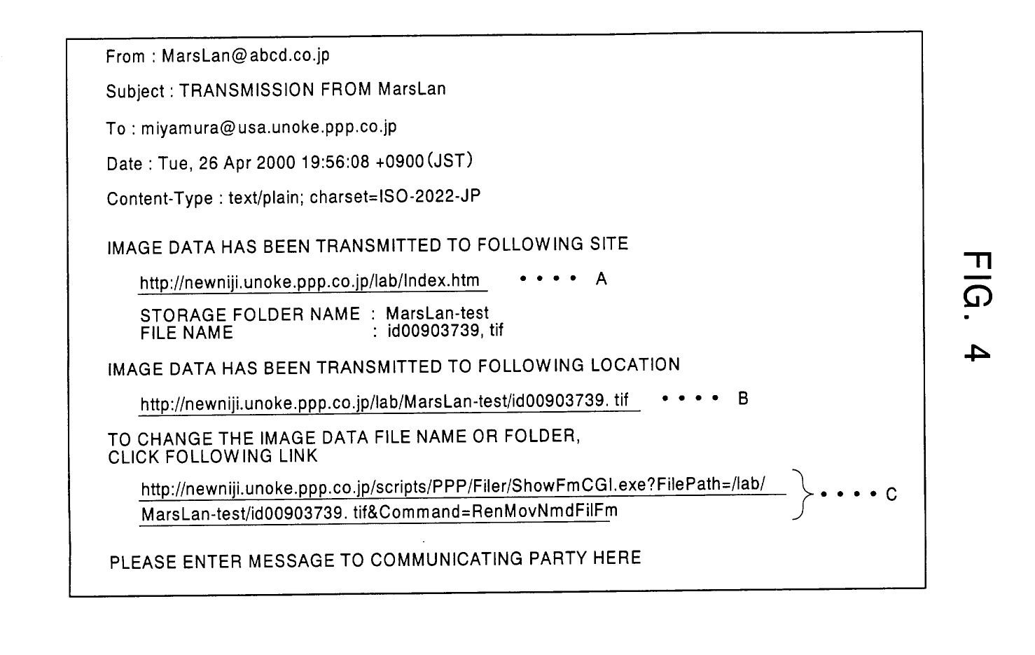

FIG. 4 shows a sample embodiment of electronic mail transmitted to a terminal 3 by the mail transmission program 23.

As shown in FIG. 4, electronic mail transmitted to a terminal 3 by the mail transmission program 23 describes URL notation, as shown in “C” in FIG. 4. That is to say, the description for the relevant URL notation includes a description of full path information for the registered file determined by the file registration program 21 (FilePath=/lab/MarsLAN-test/id00903739.tif) and a description to call a file name change or folder movement operation (scripts/PPP/Filer/ShowFmCGI.exe . . . Command=RenMovNmdFilFm). That is, the former is a description of (all) path information up to arrival at the Web filing system 1 in the LAN (network) 5, and moreover, up to arrival at the relevant registered file which is an object therein, and the latter is a description to call a predetermined function (relevant part of the relevant program) of the CGI program 11 in the Web filing system 1.

Here, “A” in FIG. 4 is the Web filing system 1 URL notation, and “B” in FIG. 4 is the registered file URL notation. These two URL notations are also written in the conventional art.

On receiving this electronic mail, a user operating a terminal 3 clicks URL notation “A” in FIG. 4 when wishing to display the initial screen of the Web filing system 1, or clicks URL notation “B” in FIG. 4 when wishing to peruse the registered file, or clicks URL notation “C” in FIG. 4 when wishing to change the file name or folder of the registered file.

Thereafter, if a user clicks URL notation “A” in FIG. 4 written in the electronic mail, the Web browser 30 placed in the terminals 3 issues a processing request to the Web service, whereby, as shown in the processing flow in FIG. 3(a), the initial screen of the Web filing system 1 is displayed in step ST11, and processing in accordance with an operation in that initial screen is executed in step ST12.

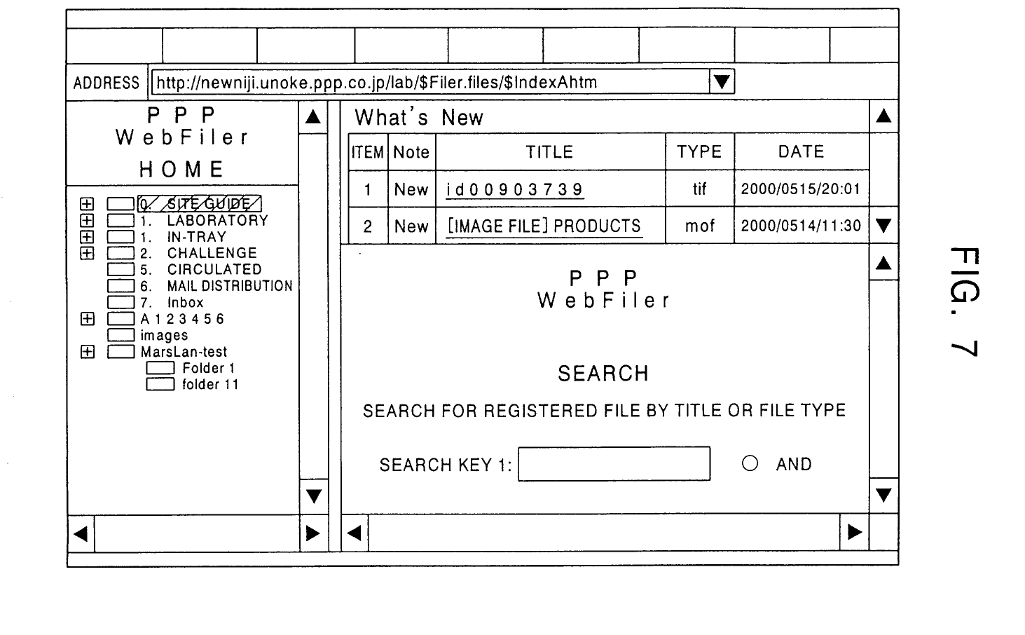

That is to say, by issuing a processing request to the Web service, a Web filing system 1 initial screen such as that shown in FIG. 7 is displayed, and processing in accordance with an operation in that initial screen is executed.

On the other hand, when a user clicks URL notation “B” in FIG. 4 written in the electronic mail, the Web browser 30 placed in terminals 3 issues a processing request to the Web service, whereby, as shown in the processing flow in FIG. 3(b), a perusal screen for the file specified by that URL notation (registered file) is displayed in step ST21, and processing in accordance with an operation in that perusal screen is executed in step ST22.

Further, when a user clicks URL notation “C” in FIG. 4 written in the electronic mail, the Web browser 30 placed in terminals 3 issues a processing request to the CGI program 11, whereby, as shown in the processing flow in FIG. 3(c), a file name change or movement operation screen is displayed in step ST31 with the file name of the file specified by that URL notation (registered file) as the current file name and the folder specified by that URL notation as the current folder, and in step ST32, the file name of the registered file is changed or the folder in which the registered file is stored is moved (changed) in accordance with an operation in that operation screen.

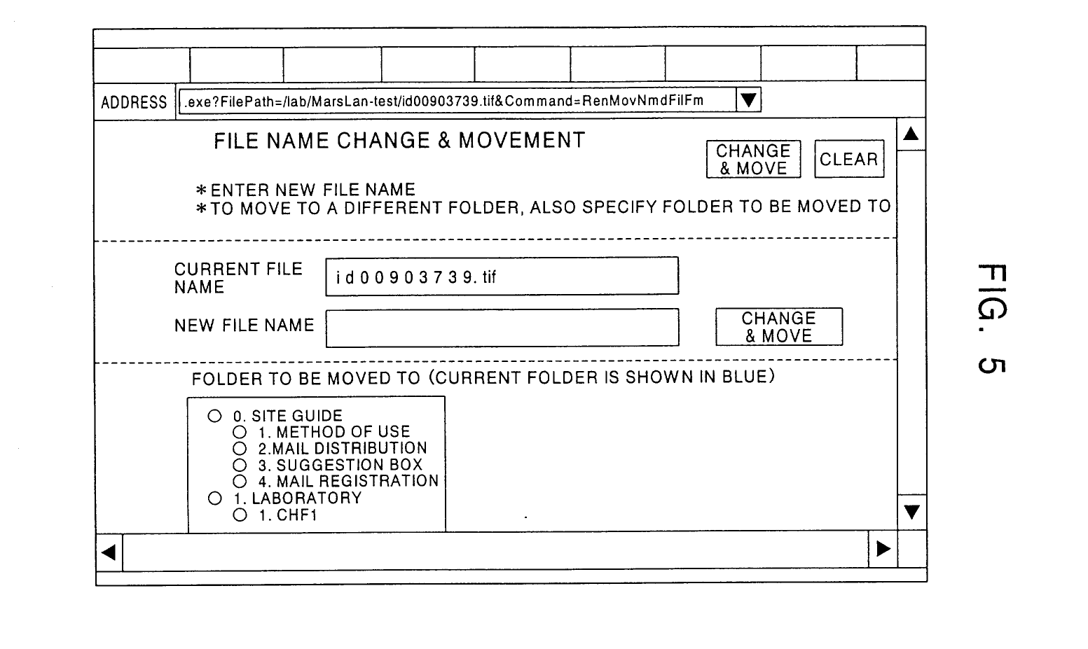

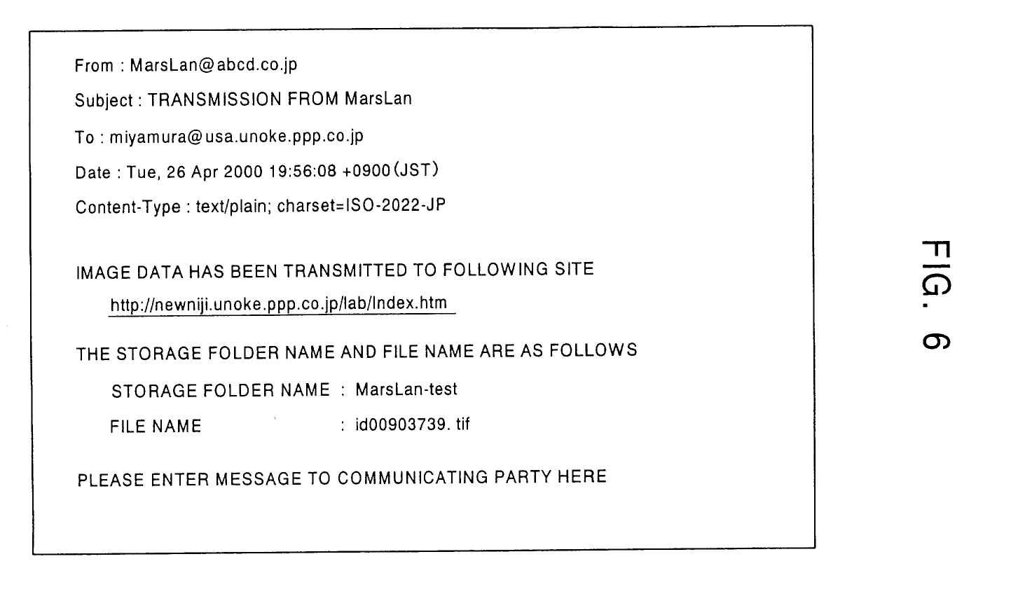

That is to say, by issuing a processing request to the CGI program 11, a file name change or movement operation screen such as that shown in FIG. 5 is displayed, and the file name of the registered file is changed or the storage folder for the registered file is moved (changed) in accordance with an operation in that operation screen.

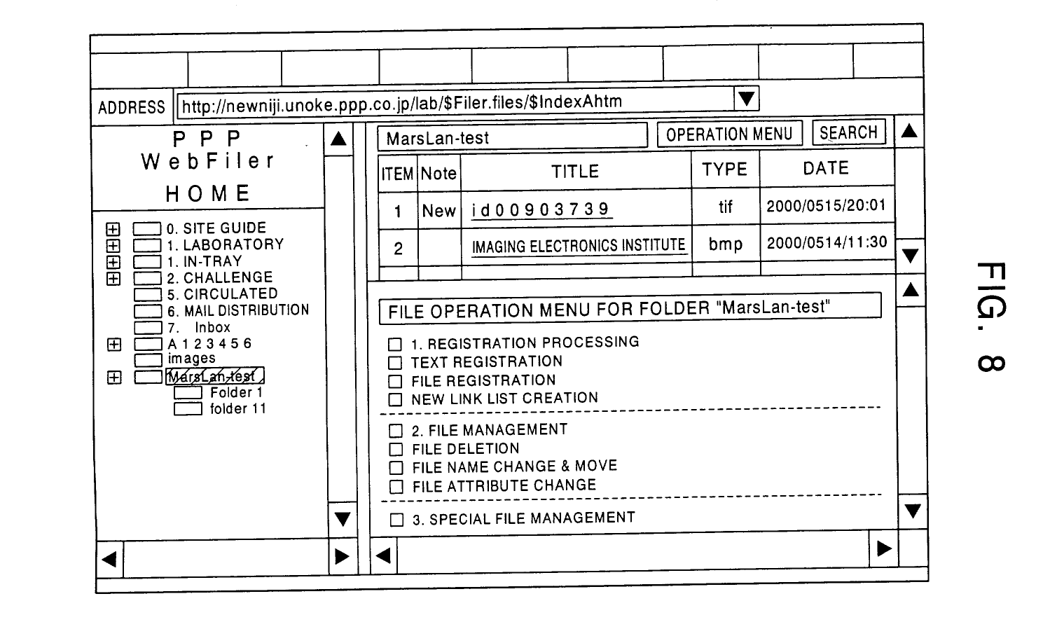

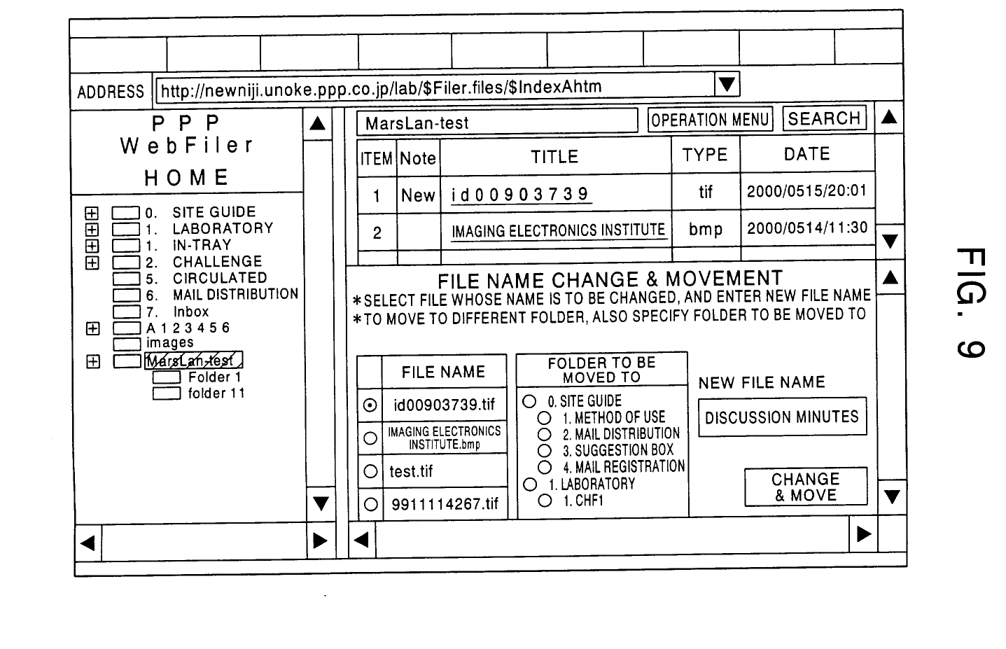

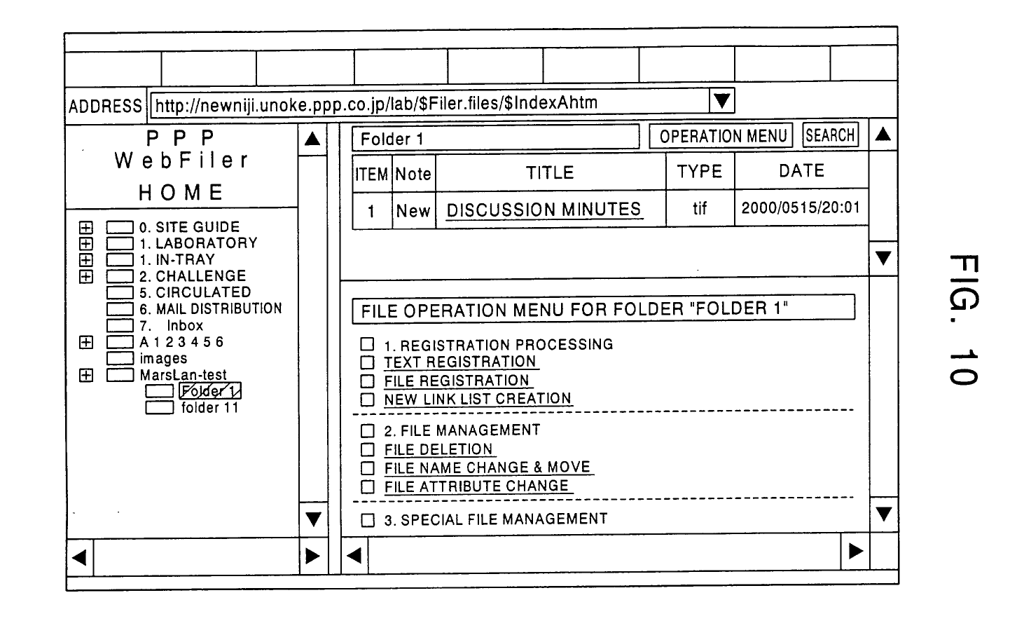

Thus, in the conventional art, when a user wishes to change the filename or storage folder of a file registered in a Web filing system 1, he or she must change the file name or storage folder by first invoking the initial screen in FIG. 7, then displaying the operation menu screen in FIG. 8 from this initial screen, and then invoking the operation screen in FIG. 9 from this operation menu screen. In contrast to this, according to the present invention, it is possible to change a file name or storage folder easily by immediately invoking the file name change or movement operation screen in FIG. 5.

In this sample embodiment, it is disclosed that a file name change or movement operation screen is calld directly by transmitting electronic mail describing URL notation including a description to call a file name change or folder movement operation to a terminal 3. However, it is also possible to call directly an operation screen other than a file name change or movement operation screen by transmitting electronic mail describing URL notation including a description to call a different operation to a terminal 3. When this configuration is used, it is preferable for the file registration program 21 to have a configuration such that the operator chooses what kind of operation screen is to be calld directly using a menu screen, etc.

### INDUSTRIAL APPLICABILITY

As described above, according to a file generation apparatus or image scanner of the present invention, it is possible for a user who receives notification of registration information to the file registered in a file posting apparatus to call a function such as a filename change function or storage folder movement function directly simply by clicking a URL notation describing the relevant file registration information, thereby enabling file names, storage folders, etc., to be changed easily. In this way, according to the present invention, a user can handle a file registered in a file posting apparatus with good operability.

Moreover, according to a program recording medium of the present invention, the above described file generation apparatus can be realized easily by providing a program for realizing the above described file generation apparatus in a form whereby it is recorded on a floppy disk, etc.

1. A file generation apparatus comprising:
file generating and registering means for generating a file and registering the file in a file posting apparatus;
URL generating means for generating URL notation that includes a description of full path information to the file registered in the file posting apparatus and a description to call a function which operates the file; and
transmitting means for transmitting file registration information that describes the URL notation to a transmission destination:

2. A file generation apparatus according to claim 1, wherein the transmitting means transmits to a transmission destination the file registration information that describes the URL notation using electronic mail.

3. A file generation apparatus according to claim 1, wherein the URL generating means generates URL notation that includes a description to call a file name change function and/or storage folder change function.

4. A file generation apparatus according to claim 1, wherein the file posting apparatus is a Web filing system and the transmission destination is a terminal.

5. A file generation apparatus according to claim 1, wherein the file generating and registering means assigns the relevant file name to the generated file by using date and time information.

6. A file generation apparatus according to claim 1, wherein the file generating and registering means uses a folder reported as a storage destination beforehand from the file posting apparatus as the storage destination of the generated file.

7. A file generation apparatus according to claim 1, wherein the full path information in URL notation generated by the URL generating means is defined based on a filename assigned by the file generating and registering means and a determined storage folder.

8. A file generation apparatus according to claim 1, wherein the description to call a function which operates the file in URL notation generated by the URL generating means is a description that calls a function provided by a CGI program provided in the file posting apparatus.

9. A program recording medium recording a program to realize a file generation apparatus to register a generated file in a file posting apparatus, wherein the program causes a computer to execute:
generating a file and registering it in a file posting apparatus;
generating URL notation including a description of full path information to the file registered in the file posting apparatus and a description to call a function for manipulating the file; and
transmitting file registration information describing the URL notation to a transmission destination.

10. An image scanner comprising:
an image processing section to read image data and generating a file;
file registering means for registering the file in a file posting apparatus;
URL generating means for generating URL notation that includes a description of full path information to the file registered in the file posting apparatus and a description to call a function which operates the file; and
transmitting means for transmitting file registration information describing the URL notation to a transmission destination.

11. An image scanner according to claim 10,
wherein the file registering means has a file transfer program to transfer the file to the file posting apparatus; and
wherein the transmitting means comprises a mail transmission program to transmit file registration information describing the URL notation to a transmission destination using electronic mail.
